(19) United States
(12) Patent Application Publication
(10) Pub. No.: US 2007/0011278 A1
(43) Pub. Date: Jan. 11, 2007

(54) TELEMATICS SYSTEM HAVING FUNCTION OF MULTI-SERVICE SERVER SELECTION, AND METHOD FOR PROVIDING VARIOUS CONTENT SERVICES

(76) Inventor: SEONG TAEG NOU, Icheon-shi Kyungki-do (KR)

Correspondence Address: IPLA P.A., 3580 WILSHIRE BLVD., 17TH FLOOR, LOS ANGELES, CA, 90010, US

(21) Appl. No.: 11/163,251

(22) Filed: Oct. 11, 2005

(30) Foreign Application Priority Data
Jul. 5, 2005 (KR) 10-2005-0060253

(51) Int. Cl. G06F 15/16

(52) U.S. Cl. 709/219

(57) ABSTRACT

A telematics system having a function of multi-service server selection and a method for providing various content services are provided. The system includes: a plurality of service providing servers for providing a plurality of content services, and transmitting information on contents to a transmitting side of the service providing server selection message; and a telematics terminal having information on the service providing servers, connected with the service providing servers, selecting at least one of the service providing servers, transmitting the service providing server selection message to the selected service providing servers, periodically receiving the contents information, and connecting with the corresponding service providing server and receiving the corresponding content.

### BACKGROUND OF THE INVENTION

1. Field of the Invention

The present invention relates to a telematics system, and more particularly, to a telematics system having a function of multi-service server selection and a method for providing various content services, in which a user can select a server providing his/her desiring content and receive the content service from the selected server, by co-owning contents provided from a plurality of telematics centers and content providing servers.

2. Description of the Related Art

In recent years, a telematics system is one of technologies attracting attention. The telematics system detects occurrence of vehicle accident or theft, guides a vehicle running path, and provides a vehicle driver with a variety of other information using a mobile communication method and a position tracing method associated with Internet. In other words, the telematics system provides information through a vehicle based on a Global Positioning System (GPS) using a mobile communication system and a GPS satellite. Accordingly, the telematics system provides a variety of mobile communication services, such as traffic information, countermeasure to an emergency situation, remote vehicle diagnosis, and the use of Internet (for example, financial transaction, provision of news, and transmission and reception of e-mail), using the GPS, a wireless communication network, and an Internet network.

In general, the telematics system includes a telematics terminal installed at a vehicle; a wireless communication network; and a telematics center providing a service having a direct relation with the vehicle, such as vehicle and driver safety, and vehicle diagnosis and control, through the wireless communication network, and connected with content providing servers and transmitting contents such as financial transaction, news, provision of e-mail, and game to the telematics terminal. The telematics center is constituted by telematics service provider, and includes a plurality of content providing servers for developing the contents and providing the developed contents.

As described above, since the telematics service providers separately develop the contents, a user of the conventional telematics terminal can use only the contents provided from his/her subscribing telematics center and the content providing server that are connected with the telematics center. Therefore, there is a drawback in that various contents are not provided.

Further, there is a drawback in that due to service providers' burden of a cost for contents development, it is difficult to develop the various contents and accordingly, the telematics terminal user is provided with only limited contents.

Accordingly, it is required to develop the various contents and co-own the contents by the telematics service providers in order to satisfy a user's desire and activate the telematics system.

### SUMMARY OF THE INVENTION

Accordingly, the present invention is directed to a telematics system having a function of multi-service server selection and a method for providing various content services that substantially overcome one or more of the limitations and disadvantages of the conventional art.

One object of the present invention is to provide a telematics system having a function of multi-service server selection and a method for providing various content services, in which a user can select a server providing his/her desiring content and receive the content service from the selected server, by co-owning contents provided from a plurality of telematics centers and content providing servers.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a telematics system having a function of multi-service providing server selection, the system including: a plurality of service providing servers for providing a plurality of content services, and upon reception of a predetermined service providing server selection message, transmitting information on contents to a transmitting side of the service providing server selection message; and a telematics terminal having information on the service providing servers, connected with the service providing servers through wire and wireless networks, selecting at least one of the service providing servers, transmitting the service providing server selection message to the selected service providing servers, periodically receiving the contents information from the corresponding service providing servers, thereby periodically updating the contents information, and upon selection of any one of the plurality of contents and request for the content service, connecting with the corresponding service providing server for the requested content service and receiving the corresponding content.

In another aspect of the present invention, there is provided a content service providing method of a telematics system having a plurality of service providing servers for providing contents, and a telematics terminal connected with the service providing servers through wire and wireless networks and having information on the service providing servers, the method including: a first step of, in the telematics terminal, selecting at least one of the service providing servers; a second step of, in the telematics terminal, receiving and updating contents information of the selected service providing server, from the selected service providing server; and a third step of, in the telematics terminal, upon request of a content service, connecting with the service providing server providing the requested content service, and receiving the corresponding content.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a concept of multi-service server selection of a telematics system according to the present invention;

FIG. 2 illustrates a construction of a telematics terminal having a function of multi-service server selection according to the first embodiment of the present invention;

FIG. 3 is a flowchart illustrating a multi-service server selection method of a telematics terminal according to the first embodiment of the present invention;

FIG. 4 is a flowchart illustrating a contents information upgrading method of a service providing server of a telematics system according to the first embodiment of the present invention;

FIG. 5 is a flowchart illustrating a service requesting method of a telematics terminal according to the first embodiment of the present invention;

FIG. 6 is a flowchart illustrating a multi-service server selection method of a telematics terminal according to the second embodiment of the present invention; and

FIG. 7 is a flowchart illustrating a service requesting method of a service providing server of a telematics system according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention selects a plurality of service providing servers providing telematics terminal user's desiring contents, from a plurality of telematics centers and a plurality of content providing servers (Hereinafter, referred to as “service providing server” in a broad sense including the telematics center and the content providing server) through a telematics terminal, and receives information on contents (Hereinafter, referred to as “contents information”) from the selected service providing server and stores the contents information, and upon user's selection of any one of the stored contents, connects to a corresponding service providing server providing the selected content and receives the selected content from the corresponding service providing server.

In the present invention, vehicle relating contents are served from the telematics center (Hereinafter, referred to as “telematics base center”) of a telematics service provider, and other contents are served from the telematics base center or other telematics centers and/or the content providing servers.

Hereinafter, a construction of the telematics system and a content service method for providing various contents according to the present invention will be described with reference to the attached drawings.

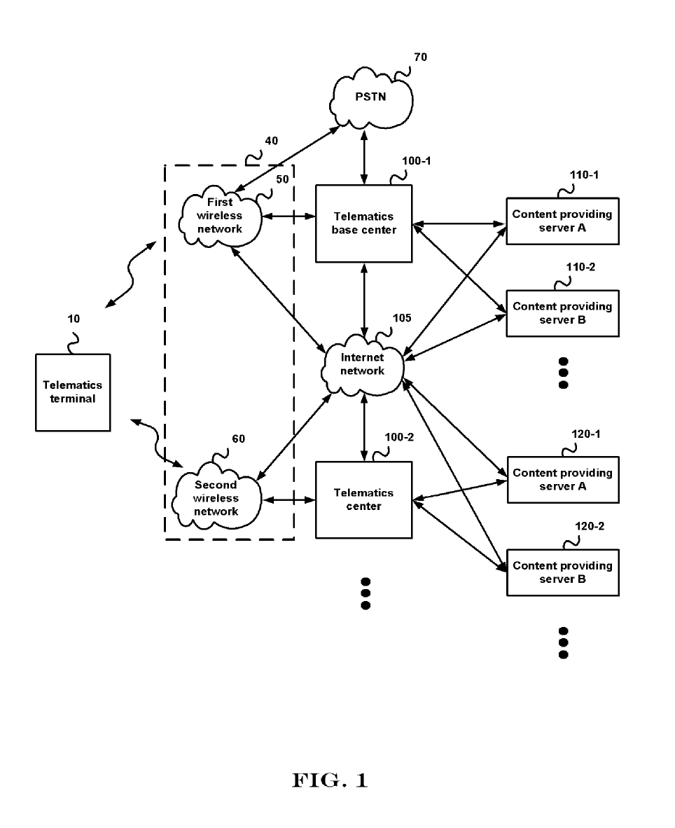

FIG. 1 illustrates a concept of multi-service server selection of the telematics system according to the present invention.

The telematics system having a function of multi-service server selection according to the present invention includes a telematics terminal 10, a wireless network 40, a public switched telephone network (PSTN) 70, Internet network 105, a plurality of telematics centers 100, and a plurality of content providing servers 110.

In FIG. 1, the telematics center 100-1 is a center where the telematics terminal 10 is registered, that is, registered as a telematics service subscriber. Hereinafter, the telematics center 100 where the telematics terminal 10 subscribes is called the telematics base center 100-1. The telematics base center 100-1 is connected with a plurality of content providing servers 110, and is connected with the Internet network 105. In the telematics center 100-2, the telematics terminal 10 is not registered as the telematics service subscriber, but is connected with a standardized center for providing the contents, that is, a plurality of content providing servers 120 and the Internet network 105.

The content providing server 110 and the content providing server 120 are respectively connected with the telematics centers 100-1 and 100-2 and connected with the Internet network 105.

The telematics terminal 10 is connected with the telematics center 100-1 or the Internet network 105 through the wireless network 40.

The wireless network 40 can be a mobile communication network (Hereinafter, referred to as “first wireless network”) 50 based on code division multiple access (CDMA), EVolution Data Only (EV-DO), Wireless CDMA (WCDMA), and EVolution Data and Video (EV-DV), or can be a wireless communication network (Hereinafter, referred to as “second wireless network”) 60 such as public wireless local area network (WLAN), Wibro, and WiMAX. The wireless network 40 can be directly connected with the telematics centers 100, and can be connected to the telematics centers 100, the content providing servers 110 and the content providing servers 120 through the Internet network 105 being a wire network, for data communication. When vehicle-relating emergency service contents, such as vehicle theft and fire, are generated from the telematics terminal 10, the first wireless network 50 directly connects to the telematics base center 100-1 to inform the telematics base center 100-1 of the generation of the emergency service contents using a short message service (SMS).

The PSTN 70 is connected with the first wireless network 50, to connect the telematics centers 100 using a wire telephone network. In case where the telematics terminal 10 performs the vehicle relating emergency service content requesting a voice call, upon request of the telematics terminal 10, the PSTN 70 connects with the telematics base center 100-1 and forms a call path, thereby enabling the voice call.

The telematics terminal 10 includes a construction for communicating data based on a mode of the wireless network 40, to communicate the data with the telematics center 100, and communicates the data with the telematics centers 100, the content providing servers 110, and the content providing servers 120 through the wireless network 40 or/and the Internet network 105. For this, the telematics terminal 10 should hold information for identifying the telematics centers 100, the content providing servers 110, and the content providing servers 120, and should be aware of contents provided from the telematics centers 100, the content providing servers 110, and the content providing servers 120. As the information for identifying the telematics centers 100, a telephone number or a uniform resource locator (URL), that is, an Internet protocol (IP) is used. As the information for identifying the service providing servers 110 and 120, the IP is used. Further, when a new content providing server is added or the contents are changed, added and deleted, the corresponding contents information is received from the telematics base center 100-1 or the corresponding content providing server through the wireless network 40, and is updated.

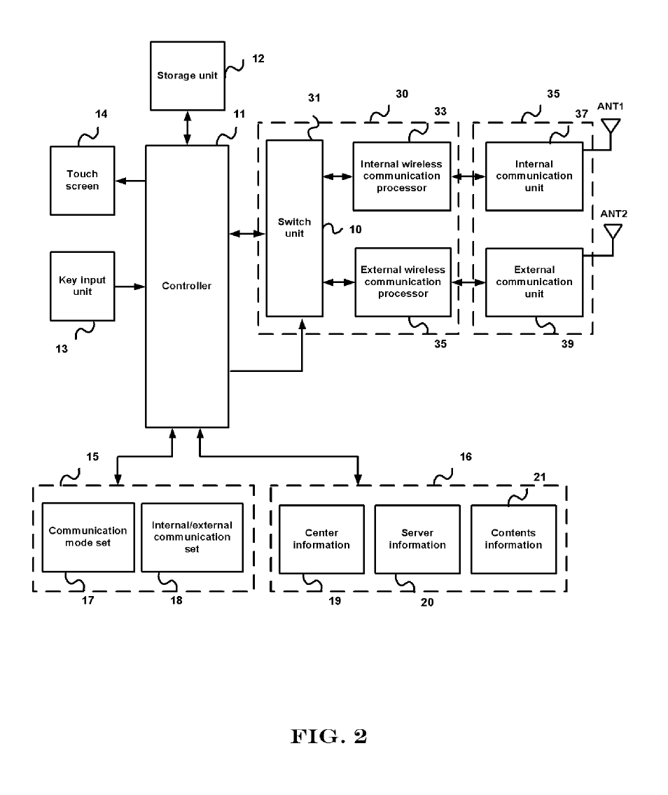

FIG. 2 illustrates a construction of the telematics terminal having a function of multi-service server selection according to the first embodiment of the present invention. A construction and an operation of the telematics terminal will be described with reference to FIG. 2 below.

The inventive telematics terminal 10 includes a controller 11, a storage unit 12, a key input unit 13, a display unit 14, a wireless communication processor 30, a communication unit 35, a communication set unit 15, and a service information storage unit 16.

The controller 111 controls a general operation of the telematics terminal 10 according to the present invention.

The storage unit 12 is comprised of a region for storing a control program for controlling an operation of the telematics terminal 10, and a region for temporarily storing data generated in execution of the control program.

The key input unit 13 includes a plurality of keys having a numeric key, a function key, a selection key, a movement key, and an end key, and generates and outputs key data to the controller 11.

The touch screen 14 is integrated with a display device and a touch pad, and displays an operation state, mode information, and buttons for controlling a function and a mode of the telematics terminal 10, and outputs a corresponding button coordinate value of the pressed button to the controller 11, thereby providing a graphic interface unit with the user.

The communication unit 35 wirelessly performs the data communication with the wireless network 40 of FIG. 1 through an antenna (ANT). The communication unit 35 is comprised of an internal communication unit 37 and an external communication unit 39. The internal communication unit 37 is installed within the telematics terminal 10, and the external communication unit 39 detachable from the telematics terminal 10 can employ a mobile communication terminal or a WLAN communication terminal.

The wireless communication processor 30 receives data from the communication unit 35 and converts the received data into a format being capable of being processed in the telematics terminal 10, and converts internal data generated from the telematics terminal 10 into a format being capable of being processed in the communication unit 37. The wireless communication processor 30 includes an internal wireless communication processor 33 corresponding to the internal communication unit 37; an external wireless communication processor 35 corresponding to the external communication unit 39; and a switch 31 for selecting one of the internal and external wireless communication processor 33 and 35 under the control of the controller 11.

The communication set unit 15 is comprised of a communication mode set unit 17 and an internal/external communication set unit 18. The internal/external communication set unit 18 sets information on whether to use the internal wireless communication processor 33 and the internal communication unit 37, or the external wireless communication processor 35 and the external communication unit 39. The controller 11 checks a set state of the internal/external communication set unit 18, and controls the switch unit 31 depending on the set or unset to determine whether the wireless data communication is performed through the internal wireless communication processor 33 or the external wireless communication processor 35. The communication mode set unit 17 sets whether to perform the data communication in any communication mode that is set to the internal/external communication set unit 18. The communication mode can be a mode such as CDMA, EV-DO, WCDMA, EV-DV, WLAN, Wibro, and WiMAX. However, among the modes, only modes compatible with the internal communication unit 37 or the external communication unit 39 can be set. For example, if the internal communication unit 37 supports the CDMA mode and the EV-DO mode evolved from the CDMA mode, one of the CDMA mode and the EV-DO mode can be selected and set through the communication mode set unit 17.

The service information storage unit 16 includes a center information storage 19 for storing information on the telematics centers 100; a server information storage 20 for storing information on the content providing servers 110 and 120; and a content information storage 21 for storing information on contents provided from the content providing servers 110 and 120. The information on the telematics centers and the content providing servers, which are stored in the center information storage 19 and the server information storage 20, are received and updated from a wireless network center for managing the telematics base center 100-1, the first wireless network 50, or the second wireless network 60, for example, from a mobile communication service center (not shown). The contents information is updated from the selected telematics center and content providing servers through the Internet network 105 and the wireless network 40.

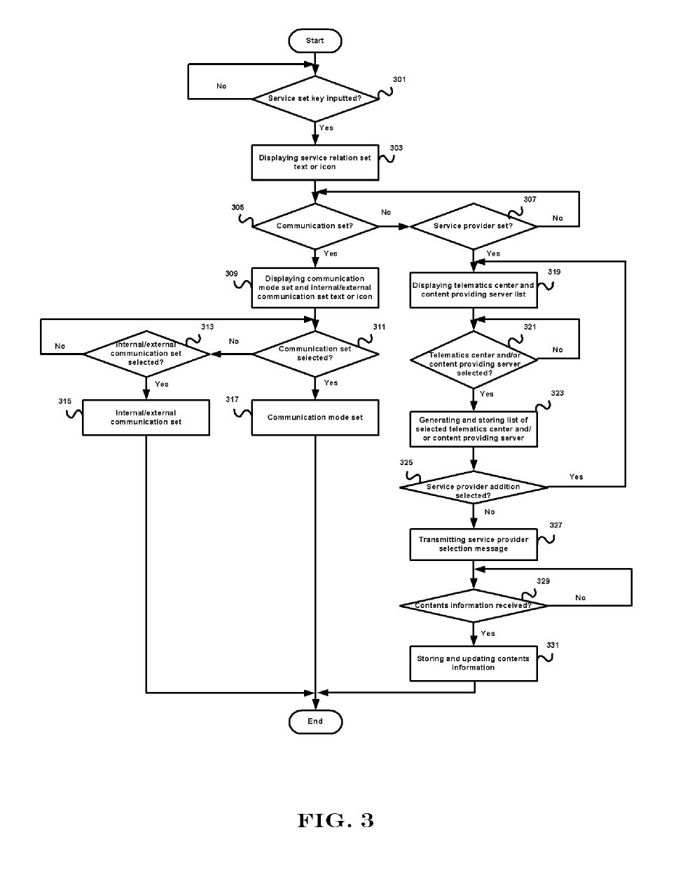

FIG. 3 is a flowchart illustrating a multi-service server selection method of the telematics terminal according to the first embodiment of the present invention. The multi-service server selection method of the telematics terminal will be described with reference to FIGS. 2 and 3 below.

First, the controller 11 checks whether or not a service set key for communication set and content providing server selection is inputted from the key input unit 13 in Step 301.

If the service set key is inputted in the Step 301, the controller 111 displays a service relation set text or icon on the touch screen 14 in Step 303.

After that, the controller 111 checks whether a communication set text or icon or a service provider set text or icon is selected in Steps 305 and 307.

If the communication set text or icon is selected in the Step 305, the controller 111 displays a communication mode set text or icon and an internal/external communication set text or icon on the touch screen 14 in Step 309.

After that, the controller 111 checks whether the communication mode set text or icon or the internal/external communication set text or icon is selected in Steps 311 and 313.

If the communication mode set text or icon is selected in the Step 311, the controller 11 sets a communication mode in Step 317. For example, the communication mode set can be made by displaying each of a CDMA mode and an EV-DO mode in a type of a selection box on the touch screen 14 and touching the selection box of the corresponding mode by the user.

If the internal/external communication set text or icon is selected in the Step 313, the controller 111 sets whether to perform the data communication through the internal communication unit 37 or the external communication unit 35 in Step 315.

Whereas, if the service provider set text or icon is selected in the Step 307, the controller 111 searches the service information storage unit 16 and displays a service provider list for the telematics centers 100 and the content providing servers 110 and 120 on the touch screen 14 in Step 319.

Next, the controller 11 checks whether or not the service provider is selected in Step 321.

If the service provider is selected in the Step 321, the controller 111 stores information on the selected service provider, that is, information on the telematics center or the content providing server, and generates and stores the selected service provider list in the contents information storage 21 of the service information storage unit 16.

Next, the controller 11 displays a message of inquiring whether or not to add the service provider, on the touch screen 14, and monitors the key input unit 13 and determines whether or not addition of the service provider is selected in Step 325.

If the service provider addition is selected in the Step 325, the above Steps starting from the Step 319 can be repeated, thereby selecting a plurality of service providers. However, a vehicle relating service such as vehicle safety and control is basically set to the telematics base center 100-1.

If the selection of the service provider is completed in the above Steps, the controller 11 transmits a service providing server selection message for informing each of the selected service providers that the service provider is selected as a service provider, depending on the communication set in Step 327.

After that, the controller 11 checks whether or not the contents information is received in Step 329.

If the contents information is received in the Step 329, the controller 11 stores or updates the received contents information in the contents storage 21 in Step 331.

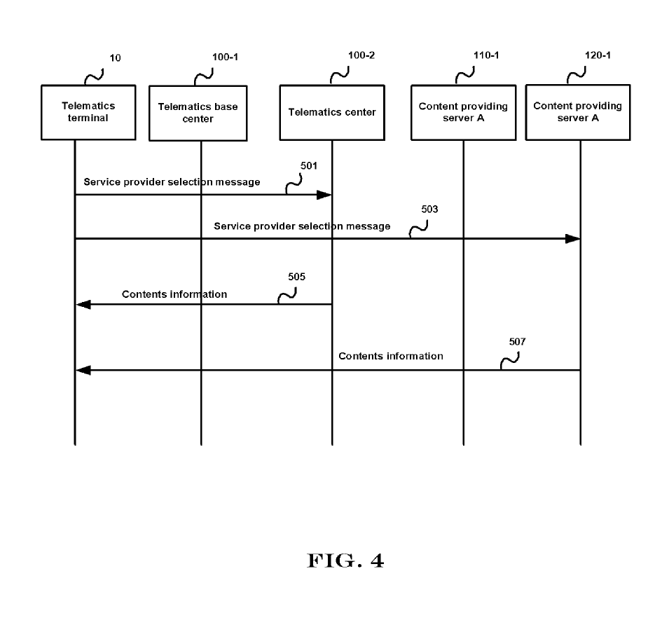

FIG. 4 is a flowchart illustrating a contents information updating method of the service providing server of the telematics system according to the first embodiment of the present invention. In case where the telematics center 100-2 and the content providing server (A) being the service provider are selected, and the communication set with the first wireless network 50 is made in FIG. 3, the contents information upgrading method depending on transmission of the service providing server selection message in the Step 327 of FIG. 3 will be described.

The telematics terminal 10 transmits two service providing server selection messages to the selected telematics server center 100-2 and content providing server A 120-1 through the first wireless network 50 in Steps 501 and 503, respectively. One of the two service providing server selection messages is transmitted to the telematics center 100-2 through the first wireless network 50 or through the first wireless network 50 and the Internet network 105, and the other is transmitted to the content providing server A 120-1 through the first wireless network 50 and the Internet network 105. Basically, the service providing server selection message is not transmitted to the selected telematics base center 100-1.

The telematics center 100-2 receives the service providing server selection message, and transmits information on contents being under service to the telematics terminal 10 through the first wireless network 50 or through the Internet network 105 and the first wireless network 50 in Step 505. At this time, the telematics terminal 10 receives and stores the contents information in the contents information storage 21.

The content providing server A 120-1 receives the service providing server selection message, and transmits contents information to the telematics terminal 10 through the Internet network 105 and the first wireless network 50 in Step 507.

In the above description, the method for telematics terminal's requesting only the selected service providing servers for the contents information and receiving and managing the contents information from the corresponding service providing servers is described, but the telematics base center 100-1 can periodically receive the contents information from the telematics centers and the content providing servers and collectively transmit the received contents information to the telematics terminal 10, thereby updating the contents information.

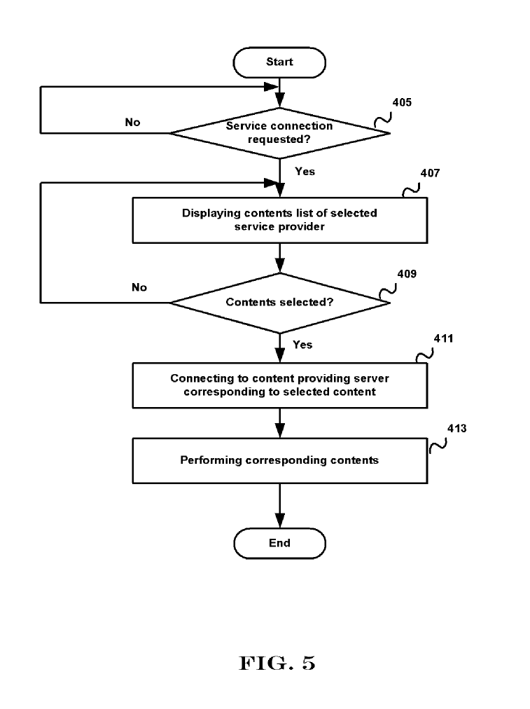

FIG. 5 is a flowchart illustrating a service requesting method of the telematics terminal according to the first embodiment of the present invention.

Referring to FIG. 5, the controller 11 of the telematics terminal 10 checks whether or not key data is inputted from the key input unit 13 and requests for a service connection in Step 405.

If the service connection is requested in the Step 405, the controller 11 displays a contents list for the contents of the selected service providing server, which is stored in the contents information storage 21, on the touch screen 14 in Step 409.

After that, the controller 11 checks whether or not one of the displayed contents is selected in Step 409.

If the content is selected in the Step 409, the controller 11 connects to the service providing server providing the selected contents in Step 411, and receives a corresponding content from the service providing server and performs a corresponding function in Step 413.

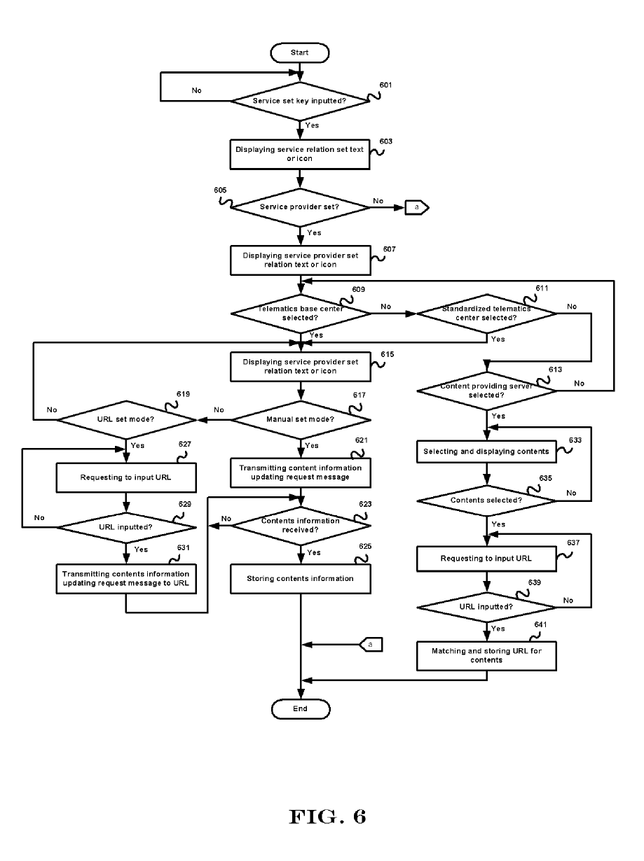

FIG. 6 is a flowchart illustrating a multi-service server selection method of a telematics terminal according to the second embodiment of the present invention. The multi-service server selection method according to the present invention will be described with reference to FIG. 6 below.

First, in Step 601, the controller 111 checks whether or not a service set command is set by the service set key or the service set button pressed through the key input unit 13 or the touch screen 14.

If the service set command is inputted in the Step 601, the controller 11 displays the service relation set text or icon or button on the touch screen 14 in Step 603. In Step 605, a command for the service provider set is inputted. If so, the controller 11 displays the service provider set relation text or icon or button on the touch screen 14 in Step 607.

After that, the controller 111 checks whether or not the telematics base center 100-1, the standardized telematics center 100-2, and the content providing server are selected in Steps 609, 611, and 613, respectively.

If the telematics base center 100-1 is selected in the Step 609, the controller 11 displays the service set relation text or icon or button in Step 615. The service set relation text or icon or button can employ an automatic set mode, a manual set mode, and a uniform resource locator (URL) set mode. Cases of the manual set and the URL set will be described below. In the present invention, the manual set mode and the URL set mode are applied to avoid the automatic set mode being unnecessarily frequent.

After the Step 615, the controller 11 checks whether or not the manual set mode and the URL set mode are selected through the key input unit 13 and the touch screen 14 in Steps 615 and 617.

If the manual set mode is selected in the Step 617, in Step 621, the controller 11 generates a contents information updating request message depending on a wire and wireless Internet protocol, a wireless protocol based on the first wireless network 50 or the second wireless network 60 or a protocol between the second wireless network 60 and the Internet network 105, and a protocol between the Internet network 105 and the telematics base center 100-1, and transmits the generated updating request message to the telematics base center 100-1 through the corresponding wireless network 50 or 60 and the Internet network 105. Further, in case where the first wireless network 50 is used, the controller 11 can also transmit the generated updating request message directly to the telematics base center 100-1, not through the Internet network 105.

After the transmission of the contents information updating request message, the controller 11 checks whether or not the contents information is received from the telematics base center 100-1 in Step 623.

If the contents information is received from the telematics base center 100-1 in the Step 623, the controller 11 stores or updates the received contents information in Step 625. The received contents information can be a URL and a telephone number for the contents provided through the corresponding telematics base center 100-1. The telephone number is used for a voice service of an automatic response system (ARS).

Whereas, if the URL set mode is selected in the Step 619, the controller 11 requests to input the URL of the telematics base center 100-1 through the touch screen 14 in Step 627, and checks whether or not the URL is inputted.

If the URL is inputted in the Step 629, the controller 11 transmits the contents information updating request message to the telematics base center 100-1 having the inputted URL in Step 631, and stores or updates the contents information by identically performing the Steps 623 and 625.

If the standardized telematics center 100, for example, the telematics center 100-2 is selected in the Step 611, the controller 11 identically performs the above Steps starting from the Step 615. However, when the manual set mode is performed in the Step 617, the controller 11 should change the URL or IP for transmitting the contents information updating request message, into a URL or IP of the telematics center 100-2.

If the content providing server is selected in the Step 613, the controller 11 displays the contents text, icon or button that is, the contents list for selecting the contents in Step 633. The contents list can be set by section, such as life information, entertainment and the voice service of the ARS, and the life information can be also set by group, such as news, weather and stock. The display of the contents list by group can be made in a top-down mode or by group.

If the contents list is displayed in the Step 633, the controller 11 checks whether or not the contents are selected in Step 635.

If the contents are selected in the Step 635, the controller 11 requests to input the URL for providing the selected contents in Step 637.

After that, the controller 111 checks whether or not the URL is inputted in Step 639, and if the URL is inputted, the controller 111 matches and stores the URL for the selected contents in Step 641.

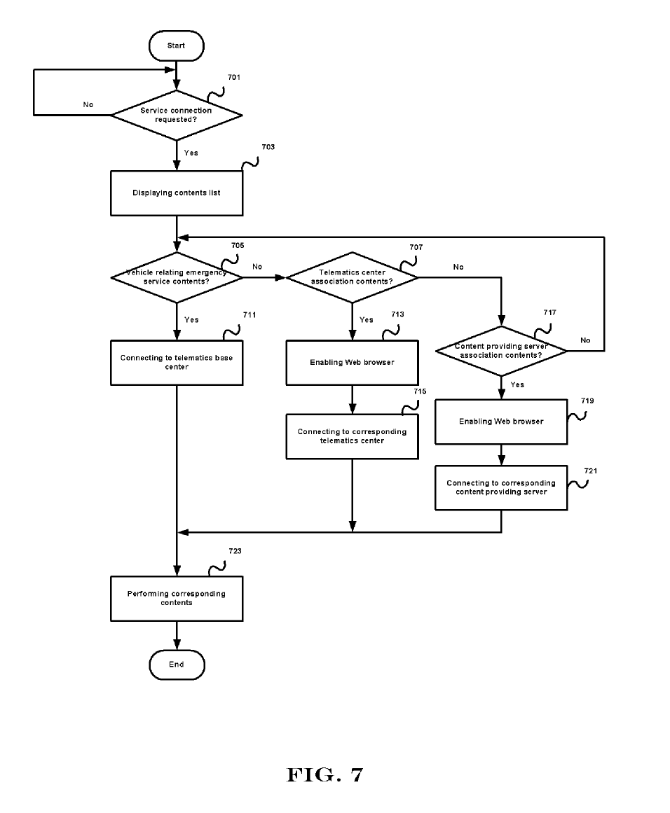

FIG. 7 is a flowchart illustrating a service requesting method of the service providing server of the telematics system according to the second embodiment of the present invention. A description will be made with reference to FIG. 7 below.

The controller 11 checks whether or not a service connection request command is inputted from the key input unit 13 or the touch screen 14 in Step 701.

If the service connection request command is inputted in the Step 701, the controller 111 displays the contents list on the touch screen 14 in the Step 703.

If the contents list is displayed, the controller 11 checks whether or not vehicle relating emergency service contents, telematics center association contents, and content providing server association contents are selected in Steps 705, 707, and 717, respectively.

If the vehicle relating emergency service contents are selected in the Step 705, the controller 111 connects to the telematics base center 100-1 in Step 711 and performs the corresponding contents in Step 723. If the selected vehicle relating emergency service contents are contents requiring the voice call, a voice call path with the telematics base center 100-1 through the first wireless network 50 and the PSTN network 70 is formed and a service is provided. Other emergency service contents are transmitted to the telematics base center 100-1 using the short message service through the first wireless network 50. The voice and short message services are used to promptly process the vehicle relating emergency service.

If the telematics center association contents are selected in the Step 707, the controller 111 enables a Web browser in Step 713, and connects to the corresponding telematics center in Step 715, and performs the corresponding contents in Step 723. In the case of the telematics center association contents, connection is made through the telematics center 100 to the content providing server providing the corresponding contents. This is for authentication and billing based on provision of the contents.

If the content providing server association contents are selected in Step 717, the controller 111 enables the Web browser in Step 719, and connects to the corresponding content providing server in Step 721, and performs the corresponding contents in Step 723.

As described above, the present invention has an advantage in that the contents can be provided from a plurality of telematics centers and content providing servers to the telematics terminal.

Further, the present invention has an advantage in that owing to provision of various contents, telematics terminal user's satisfaction can be enhanced and further, the telematics system can be activated.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A telematics system having a function of multi-service providing server selection, the system comprising:
a plurality of service providing servers for providing contents;
a telematics terminal for allowing a user to select the service providing server providing the contents by content, storing information on the selected service providing server by content, and upon user's selection of any content, connecting to the service providing server for providing the selected content, thereby performing the content.

2. The system according to claim 1, wherein if the selected content is a vehicle relating emergency service content, the service providing server for the content is a telematics base center.

3. The system according to claim 2, wherein the information on the service providing server is a telephone number of the telematics base center.

4. A content service providing method of a telematics system having a plurality of service providing servers for providing contents and a telematics terminal connected to the service providing servers through a wireless network and a wire network to receive the contents, the method comprising the steps of:
in the telematics terminal, selecting and setting each service providing server by content; and
upon generation of a content service request, connecting to the corresponding service providing server and performing the content.

5. The method according to claim 4, wherein if the selected content is a vehicle relating emergency service content, the service providing server for the content is a telematics base center.

6. The method according to claim 5, wherein information on the service providing server is a telephone number of the telematics base center.

7. A telematics system having a function of multi-service providing server selection, the system comprising:
a plurality of service providing servers for providing a plurality of content services, and upon reception of a predetermined service providing server selection message, transmitting information on contents to a transmitting side of the service providing server selection message; and
a telematics terminal having information on the service providing servers, connected with the service providing servers through wire and wireless networks, selecting at least one of the service providing servers, transmitting the service providing server selection message to the selected service providing servers, periodically receiving the contents information from the corresponding service providing servers, thereby periodically updating the contents information, and upon selection of any one of the plurality of contents and request for the content service, connecting with the corresponding service providing server for the requested content service and receiving the corresponding content.

8. The system according to claim 7, wherein the service providing servers are a telematics base center, a plurality of telematics centers of other telematics service providers, and a plurality of content providing servers.

9. A content service providing method of a telematics system having a plurality of service providing servers for providing contents, and a telematics terminal connected with the service providing servers through wire and wireless networks and having information on the service providing servers, the method comprising:
a first step of, in the telematics terminal, selecting at least one of the service providing servers;
a second step of, in the telematics terminal, receiving and updating contents information of the selected service providing server, from the selected service providing server; and
a third step of, in the telematics terminal, upon request of a content service, connecting with the service providing server providing the requested content service, and receiving the corresponding content.

10. The method according to claim 9, wherein the third steps comprises the steps of:
upon telematics terminal's selection of the service providing server, connecting with the selected service providing server, and transmitting a service providing server selection message for informing that the service providing server is selected, to the service providing server;
in the service providing server, receiving the service providing server selection message, and transmitting information on updated contents, to the telematics terminal; and in the telematics terminal, receiving the contents information and updating the corresponding contents information.
